(19) United States
(12) Patent Application Publication
(10) Pub. No.: US 2012/0209863 A1
(43) Pub. Date: Aug. 16, 2012

(54) INFORMATION PROCESSING APPARATUS

(75) Inventors: Shigeru HIDESAWA, Kawasaki (JP); Kazuma MAKITA, Kawasaki (JP)

(73) Assignee: FUJITSU LIMITED, Kawasaki-shi (JP)

(21) Appl. No.: 13/344,353

(22) Filed: Jan. 5, 2012

(30) Foreign Application Priority Data
Feb. 10, 2011 (JP) 2011-027166

(51) Int. Cl. G06F 17/30

(52) U.S. Cl. 707/755; 707/E17.009

(57) ABSTRACT

An information processing apparatus includes a processor. The processor acquires a question sentence corresponding to a term included in a message transmitted to a receiving terminal used by a receiver, acquires from the message a character string corresponding to the term, and generates test information including the question sentence and the character string as a correct answer to the question sentence.

### CROSS-REFERENCE TO RELATED APPLICATION

This application is based upon and claims the benefit of priority of the prior Japanese Patent Application No. 2011-027166, filed on Feb. 10, 2011, the entire contents of which are incorporated herein by reference.

### FIELD

The embodiments discussed herein are related to an information processing apparatus.

### BACKGROUND

Traditionally, emails have been transmitted and received through communication networks such as the Internet and local area networks (LANs) in order to provide various types of notices such as that of meeting schedules, communications regarding request items, job-related instructions or the like. An email, a tool called groupware, a system for managing workflows and the like are known as tools for providing such notices.

Traditionally, when information regarding a meeting schedule is received, for example, the schedule is registered in a schedule management tool and managed using the schedule management tool. The schedule management tool is provided as one of functions of groupware in some cases.

Japanese Laid-open Patent Publication No. 2007-94055 and Japanese Laid-open Patent Publication No. 2004-362075 disclose related techniques.

### SUMMARY

According to an aspect of the present invention, provided is an information processing apparatus including a processor. The processor acquires a question sentence corresponding to a term included in a message transmitted to a receiving terminal used by a receiver, acquires from the message a character string corresponding to the term, and generates test information including the question sentence and the character string as a correct answer to the question sentence.

The object and advantages of the invention will be realized and attained by means of the elements and combinations particularly pointed out in the claims. It is to be understood that both the foregoing general discussion and the following detailed discussion are exemplary and explanatory and are not restrictive of the invention, as claimed.

### BRIEF DESCRIPTION OF DRAWINGS

FIG. 1 is a diagram illustrating an exemplary configuration of an information processing system according to an embodiment of the present invention;

FIG. 2 is a diagram illustrating an exemplary operation flow of client terminals and servers included in an information processing system according to an embodiment of the present invention;

FIG. 3 is a diagram illustrating an exemplary hardware configuration of a text analysis server according to an embodiment of the present invention;

FIG. 4 is a diagram illustrating an exemplary configuration of a database for text analysis used by a text analysis server according to an embodiment of the present invention;

FIG. 5 is a diagram illustrating an exemplary operation flow of a text analysis server according to an embodiment of the present invention;

FIG. 6 is a diagram illustrating an exemplary operation flow of a test generation server according to an embodiment of the present invention;

FIG. 7 is a diagram illustrating an exemplary data format of understanding level test data according to an embodiment of the present invention;

FIG. 8 is a diagram illustrating an exemplary screen for displaying an email including an understanding level test according to an embodiment of the present invention;

FIG. 9 is a diagram illustrating an exemplary operation flow of a communication result management server according to an embodiment of the present invention;

FIG. 10 is a diagram illustrating an exemplary data format of test result data according to an embodiment of the present invention;

FIG. 11 is a diagram illustrating an exemplary screen for displaying a check result according to an embodiment of the present invention;

FIG. 12 is a diagram illustrating an exemplary data format of basic data for transmission of an alarm email according to an embodiment of the present invention;

FIG. 13 is a diagram illustrating an exemplary data format of an auxiliary database according to an embodiment of the present invention;

FIG. 14 is a diagram illustrating an exemplary operation flow of a communication result management server according to an embodiment of the present invention;

FIG. 15 is a diagram illustrating an exemplary screen for registering a schedule according to an embodiment of the present invention;

FIG. 16 is a diagram illustrating an exemplary screen for displaying a check result according to an embodiment of the present invention;

FIG. 17 is a diagram illustrating an exemplary operation flow of client terminals and servers included in an information processing system according to an embodiment of the present invention;

FIG. 18 is a diagram illustrating an exemplary operation flow of a text analysis server according to an embodiment of the present invention; and

FIG. 19 is a diagram illustrating an exemplary operation flow of a communication result management server according to an embodiment of the present invention.

### DESCRIPTION OF EMBODIMENTS

In the aforementioned conventional operations, a user (a transmitter) transmits a message including a notice, a communication item, an instruction, or the like, for example. However, such a tool has not been proposed that helps the transmitter confirm whether a user (a receiver) received the message has correctly understood the message and performed a task in accordance with the message.

For example, the transmitter needs to confirm whether the receiver has registered the meeting schedule in schedule management data of the groupware in some cases. In such a case, the transmitter may perform follow-up by transmitting another message to confirm whether the meeting schedule has been registered. Thus, a conventional system has a problem that the confirmation is cumbersome.

Accordingly, it is preferable to provide a technique for determining whether the receiver has understood the content of the message to achieve efficient communication in an environment allowing message exchange.

An information processing apparatus discussed herein may improve the convenience of communication of information in an environment allowing message exchange between users.

Embodiments will be discussed with reference to the accompanying drawings.

### First Embodiment

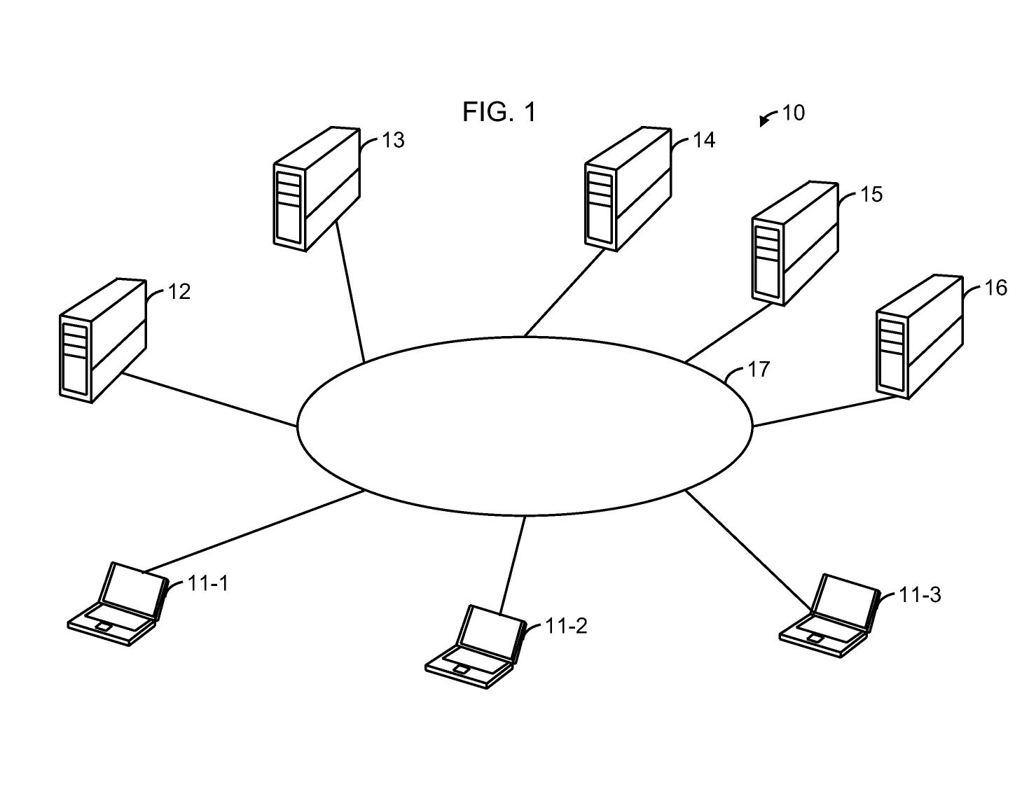

FIG. 1 illustrates an exemplary configuration of an information processing system 10 according to a first embodiment of the present invention. In the first embodiment, the information processing system 10 includes a plurality of client terminals 11-1 to 11-3 and a plurality of servers, for example. The plurality of servers provide services to the plurality of client terminals 11-1 to 11-3. In the example illustrated in FIG. 1, the plurality of servers include a text analysis server 12, a test generation server 13, a mail server 14, a communication result management server 15 and a schedule management server 16.

Among the servers of the information processing system 10, the text analysis server 12 analyzes a text of a message. The message is a communication message (such as an email) that is transmitted from any of the plurality of client terminals 11-1 to 11-3 to another one of the client terminals 11-1 to 11-3, for example. The analysis of the text means to analyze syntax of the message, divide the message into terms (words), extract terms (words) from the message, process the extracted terms (words), and the like, for example.

In the present embodiment, an email is used as an example of a tool for transmitting and receiving a message in many cases. However, the tool for transmitting and receiving a message is not limited to an email. Examples of the tool for transmitting and receiving a message are a communication tool that is achieved by groupware, and a communication tool that is achieved by a workflow management system. A terminal that is among the plurality of client terminals 11-1 to 11-3 and transmits a message is referred to as a transmitting terminal. A terminal that is among the plurality of client terminals 11-1 to 11-3 and receives a message is referred to as a receiving terminal. A user who uses the transmitting terminal that transmits a message is merely referred to as a transmitter, while a user who uses the receiving terminal that receives a message is merely referred to as a receiver.

The test generation server 13 generates a test, which is referred to as an understanding level test, on the basis of a result of the analysis performed by the text analysis server 12. It may be said that the understanding level test is a test that is used to determine whether the user of the receiving terminal has understood the content of a received message.

The mail server 14 manages transmission and reception of emails among the client terminals 11-1 to 11-3. In the present embodiment, an email is transmitted while including the understanding level test generated by the test generation server 13 and a message to be transmitted and received between the users.

The communication result management server 15 manages a result of message communication on the basis of a result of the understanding level test generated by the test generation server 13. The management of the result of the message communication means to confirm whether the receiver of the message has correctly understood the message and performed a task in accordance with the message, for example. The management of the result of the message communication also means to take measures (such as follow-up for the receiver after the confirmation) to make the user understand the message.

The schedule management server 16 manages a schedule for a group through groupware, for example. In the present embodiment, the information processing system 10 may not include the schedule management server 16.

The plurality of client terminals 11-1 to 11-3 and the servers 12 to 16 are connected to one another through a communication network 17. The example illustrated in FIG. 1 includes the three client terminals. However, the number of client terminals is not limited. In addition, the communication network 17 is not limited. For example, the communication network 17 may be a public network such as the Internet. The communication network 17 may be an LAN, an in-house network including a plurality of LAN segments, in-house networks connected through a dedicated network or a virtual private network (VPN), or the like.

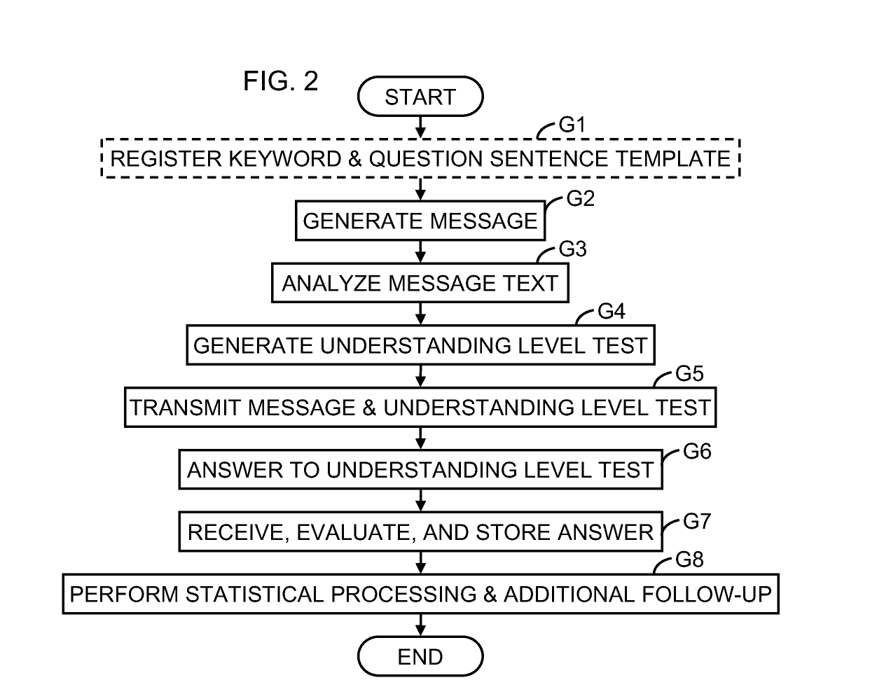

FIG. 2 illustrates an exemplary operation flow of the client terminals 11-1 to 11-3 and the servers 12 to 16 included in the information processing system 10 according to the present embodiment.

In G1, a keyword and a question sentence template are registered in preparation for the analysis of the message text, the generation of the understanding level test, and the like in the information processing system 10. The registration of the keyword and the question sentence template may be performed in advance separately from the analysis of the message text, the generation of the understanding level test, and the like in the information processing system 10 in many cases. Thus, the operation of G1 is depicted by a broken line in FIG. 2.

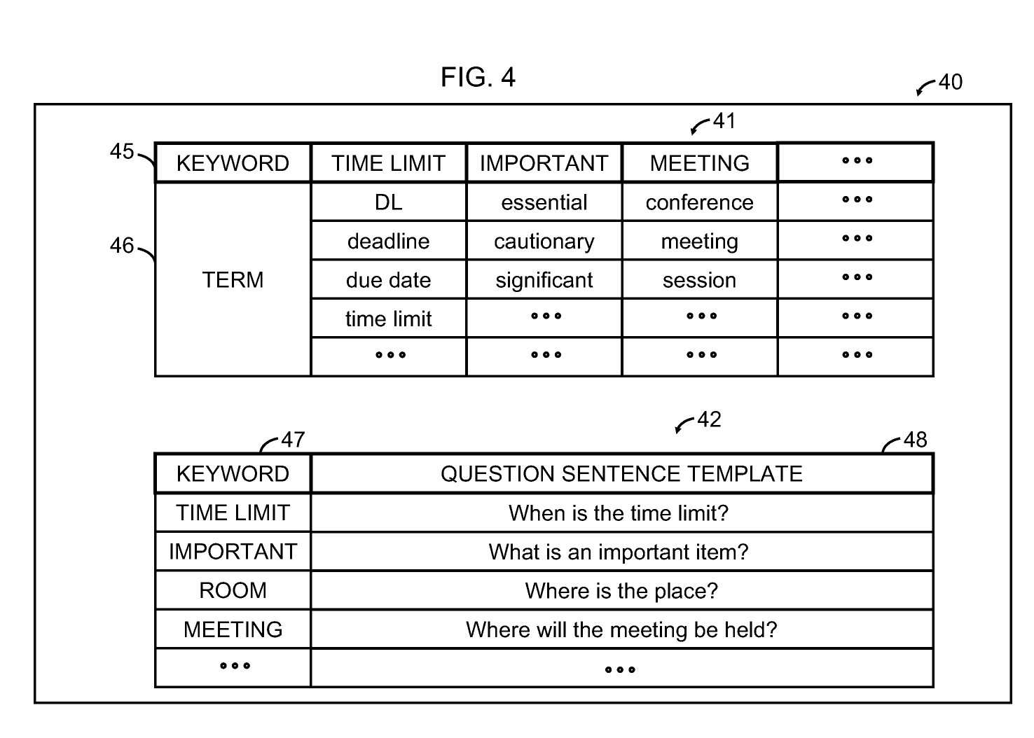

The terms acquired from the message subjected to the text analysis are classified into term groups. The keyword is a word that represents a concept of each of term groups and is representative of the terms included in the term group. An example of the term groups will be discussed later with reference to FIG. 4. The question sentence template is an exemplary question sentence or a sample of a question sentence prepared for the keyword. The information processing system 10 extracts a term from the message subjected to the text analysis and identifies a keyword of a term group including the extracted term. Then, the information processing system 10 determines a question sentence template that corresponds to the identified keyword and generates a question sentence on the basis of the determined question sentence template.

In G2, after the keyword and the question sentence template are registered, the information processing system 10 starts operations thereof. First, one of the client terminals 11-1 to 11-3 and the like generates a message such as an email in accordance with a user operation. The message is not limited to the email. The message may be a communication message that is transmitted and received between members of a group using the groupware or the like. The message may be an instruction, a communication message, a request, a demand or the like, which is transmitted and received in accordance with a workflow in the workflow management system or the like. The information processing system 10 provides a tool that enables the transmitter to confirm whether the receiver has understood a message transmitted to the receiver from the transmitter.

In G3, the transmitting terminal transmits the generated message to the text analysis server 12. Then, the text analysis server 12 analyzes the message text. In the analysis of the message text, the text analysis server 12 extracts a term from the message, identifies a term group including the extracted term, and extracts a keyword that is representative of the identified term group. In addition, the text analysis server 12 identifies a question sentence template that corresponds to the extracted keyword. Then, the text analysis server 12 transmits, to the test generation server 13, the message subjected to the text analysis, the term extracted from the message, the keyword, the question sentence template, and the like.

In G4, the test generation server 13 generates an understanding level test. The understanding level test is a test that is used to determine whether the receiver has understood the content of the message. Data of the understanding level test includes a question sentence and data (referred to as correct answer data) of a correct answer. For example, the test generation server 13 generates a question sentence on the basis of the received question sentence template. The question sentence describes a question relating to the term extracted from the message. In addition, the test generation server 13 extracts a word or a phrase located in the vicinity of the extracted term in the message, as a correct answer to the question sentence. For example, the data of the generated understanding level test is transmitted from the test generation server 13 through the text analysis server 12 to the one of the client terminals 11-1 to 11-3, which has generated the message. The test generation server 13 may transmit the data of the generated understanding level test directly to the one of the client terminals 11-1 to 11-3, which has generated the message, without through the text analysis server 12.

In the example illustrated in FIG. 1, the text analysis server 12 and the test generation server 13 are computers that are separated from each other. However, the text analysis server 12 and the test generation server 13 may function in the same computer. In addition, when the transmitter of the message generates the message, the transmitting terminal, the text analysis server 12 and the test generation server 13 may cooperate with one another so as to perform the operations of G3 and G4. For example, the transmitting terminal, the text analysis server 12 and the test generation server 13 may transmit and receive information through a user interface screen on a screen of the transmitting terminal and perform the operations of G3 and G4. The transmitting terminal may perform the function of the text analysis server 12 and the function of the test generation server 13. Any of the functions provided by the information processing system 10 may be performed by any of the computers included in the information processing system 10 in accordance with a configuration arranged by a general expert.

In G5, upon receiving the understanding level test, the transmitting terminal transmits the message and the data of the understanding level test to the receiving terminal through the mail server 14, for example. The transmitting terminal may transmit the message to the receiving terminal with measures other than emails, such as a system of the groupware or the workflow management system.

In G6, the receiver of the message reads the message on the receiving terminal. In this case, the receiving terminal displays the message and the question sentence of the understanding level test and does not display the correct answer data. The receiver of the message makes answer to the question sentence of the understanding level test on the receiving terminal. The understanding level test and the answer of the receiver are transmitted from the receiving terminal to the communication result management server 15. The correct answer data may be separated from the message and the question sentence and transmitted from the transmitting terminal to the communication result management server 15.

In G7, the communication result management server 15 receives the answer of the receiver to the understanding level test, evaluates the content of the answer, and stores a communication result. The evaluation of the content of the answer means to determine whether the content of the answer matches the correct answer data, for example. The storage of the communication result means to store, in a nonvolatile storage device or the like, the content of the answer, the evaluation result and information for identifying the receiver who has answered the question sentence of the understanding level test. The information for identifying the receiver may be an email address, a user identifier (ID) used in the workflow management system, a user ID used for the groupware, a company's employee number, an organization's member number, or the like.

The communication result management server 15 may transmit the content of the answer and the evaluation result to the transmitting terminal and notify the transmitter of the understanding level of the receiver. When the answer is incorrect, the communication result management server 15 may request the receiver (answerer) to answer the question sentence of the understanding level test again.

In G8, the communication result management server 15 performs statistical processing on answers and performs additional follow-up. The statistical processing means to calculate the percentage of correct answers provided by each of receivers, to store data of a temporal transition of each of the percentages, and the like. The additional follow-up means to transmit a cautionary message to the receiver, to transmit a report regarding the situation to a boss of the receiver, or the like, when the percentage of correct answers provided by the receiver does not reach a reference value.

The communication result management server 15 may perform the operation of G8 every time the communication result management server 15 receives an answer. The communication result management server 15 may periodically perform the operation of G8 regardless of whether the communication result management server 15 has received an answer. For example, the communication result management server 15 may perform the operation of G8 once every day, once every week, once every month, or the like. The communication result management server 15 may perform the operation of G8 when the number of answers received by the communication result management server 15 reaches a reference value. For example, the communication result management server 15 may perform the operation of G8 every time the number of answers received by the communication result management server 15 reaches 10, 100, 1000, or the like.

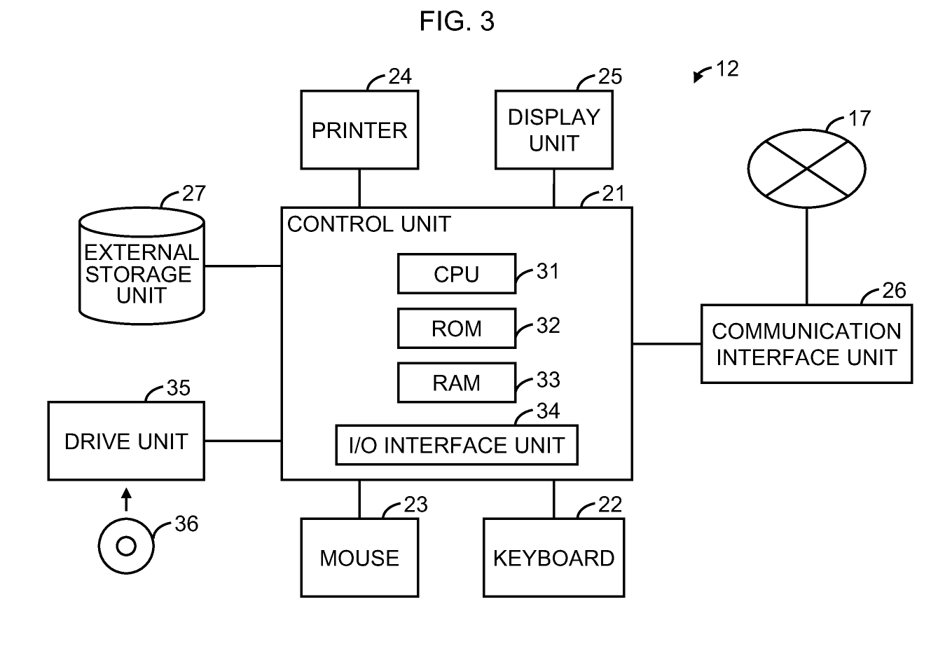

FIG. 3 illustrates an exemplary hardware configuration of the text analysis server 12. The servers 12 to 16 illustrated in FIG. 1 each has similar hardware configuration to the hardware configuration illustrated in FIG. 3. The hardware configuration of the text analysis server 12 will be discussed as an example.

The text analysis server 12 includes a control unit 21 that controls the text analysis server 12. The control unit 21 may be connected to input devices such as a keyboard 22 and a mouse 23, which are used to input various types of information to the text analysis server 12. Another input device such as a touch panel may be used instead of the keyboard 22, the mouse 23 or the like.

The text analysis server 12 may be connected to a printer 24 and a display unit 25. The printer 24 prints various types of information. The display unit 25 displays various types of information. The text analysis server 12 includes a communication interface unit 26 for interfacing between the text analysis server 12 and another apparatus in the communication through the communication network 17 such as the Internet. The text analysis server 12 includes an external storage unit 27 capable of storing a large amount of data. Examples of the external storage unit 27 are a hard disk drive and a solid state disk (SSD). The text analysis server 12 may include a drive unit 35 for reading data from and/or writing data to a computer-readable medium 36 attachable to and detachable from the text analysis server 12. Examples of the computer-readable medium are a flash memory card, a compact disc (CD), a digital versatile disc (DVD) and a Blu-ray disc.

The control unit 21 is a processing unit of the computer, for example. The control unit 21 includes a central processing unit (CPU) 31, a read only memory (ROM) 32, a random access memory (RAM) 33, and an input/output (I/O) interface unit 34. The RAM 33 stores, in a form executable by the CPU 31, a program that causes the CPU 31 to execute operations. In addition, the RAM 33 temporarily stores various types of data to be processed by the CPU 31. The I/O interface unit 34 interfaces between the control unit 21 and the external units in input/output operations. The external units are the external storage unit 27, the communication interface unit 26, the keyboard 22, the mouse 23 and the like, for example.

The external storage unit 27 stores a database (DB) used by the text analysis server 12, for example. The hardware configuration of the test generation server 13 and the hardware configuration of the communication result management server 15 are similar to the hardware configuration of the text analysis server 12, and a discussion thereof will be omitted.

When the client terminals 11-1 to 11-3 are connected to the text analysis server 12 through the communication network 17, the client terminals 11-1 to 11-3 are able to use the function of analyzing a text. When the client terminals 11-1 to 11-3 are connected to the mail server 14, the client terminals 11-1 to 11-3 are able to use a function of transmitting and receiving an email. When the client terminals 11-1 to 11-3 are connected to the communication result management server 15, the client terminals 11-1 to 11-3 are able to use a function of managing a communication result. Thus, when the client terminals 11-1 to 11-3 are connected to the servers through the network, the client terminals 11-1 to 11-3 are able to learn whether the receiver has understood the message included in the email or the like and whether an operation according to the content of the message has been performed. In addition, when the client terminals 11-1 to 11-3 are connected to the schedule management server 16, the client terminals 11-1 to 11-3 are able to use a function of managing a group schedule using the groupware. One or more functions of the servers illustrated in FIG. 1, such as the text analysis server 12, the test generation server 13, the communication result management server 15, the schedule management server 16, may be installed in the client terminals 11-1 to 11-3 and the like. A single computer may provide the functions of the servers 12 to 16 illustrated in FIG. 1 to the client terminals 11-1 to 11-3 and the like.

As the client terminals 11-1 to 11-3, terminals that provide functions of a personal computer, a personal digital assistant (PDA), a mobile phone, a personal handyphone system (PHS), and an electronic book may be used. Specifically, the client terminals 11-1 to 11-3 each includes a personal computer body provided with a CPU, an ROM, an RAM and a communication interface unit and each includes peripheral devices. Examples of the peripheral devices are input devices such as a keyboard and a mouse, which are connected to the personal computer body and used to input various types of information. Other examples of the peripheral devices are a display device that displays various types of information and a printer device that prints out various types of information.

FIG. 4 illustrates an exemplary configuration of a database for the text analysis used by the text analysis server 12. The database for the text analysis used by the text analysis server 12 may be stored in the external storage unit 27 as discussed above.

The database 40 for the text analysis includes the keyword DB 41 and the question sentence template DB 42. The keyword DB 41 stores information regarding relationship between a keyword and terms included in messages such as emails. The keyword DB 41 is an example of the storage unit for storing a keyword.

The question sentence template DB 42 stores information regarding relationship between a question sentence template and a keyword stored in the keyword DB 41 and corresponding to a term included in a message such as an email. The question sentence template DB 42 is an example of the storage unit for storing a question sentence.

Thus, the keyword DB 41 and the question sentence template DB 42 may allow the text analysis server 12 to identify a question sentence for the message such as an email.

As illustrated in FIG. 4, the keyword DB 41 has a keyword data section 45 and a term data section 46. The keyword data section 45 stores a keyword (a representative term). The term data section 46 stores one or more terms that correspond to the keyword. The keyword is also referred to as a representative term. The reason that the keyword is referred to as the representative term is that the keyword is representative of a term group including a plurality of terms and has a role in representing a concept of the term group. In the example illustrated in FIG. 4, a keyword “TIME LIMIT” is stored as a representative of a concept of a term group of terms “DL”, “deadline”, “due date” and “time limit”. Terms (such as “DL”) including an abbreviation, an idiom, or a phonetic equivalent may be included in a term group.

The question sentence template DB 42 has a keyword data section 47 and a question sentence template section 48. The keyword data section 47 stores the keyword. The question sentence template section 48 stores a question sentence template that corresponds to the keyword. FIG. 4 provides, as examples of the question sentence templates, question sentences that do not include a modifiable part. For example, a question sentence template “When is the time limit?” is provided for the keyword “TIME LIMIT”. Instead of the example illustrated in FIG. 4, each of the question sentence templates may be defined using a format including a modifiable part. For example, like a question sentence template “When is the time limit for an <action>?”, a variable <action> or the like may be included in the question sentence template. For example, a time limit for completion of a specific action is managed by applying to the variable <action> a term which indicates the specific action and is extracted from the message. In addition, for a counterpart for whom the action takes place, a variable <counterpart> may be included in the question sentence template.

For example, the test generation server 13 that receives the question sentence template from the text analysis server 12 may extract a term corresponding to the variable <action> from the message on the basis of a modifier that is included in the message and located before or after the term “time limit”. Then, the test generation server 13 may substitute the extracted term into the variable <action> and thereby adjusts the question sentence template to the actual message.

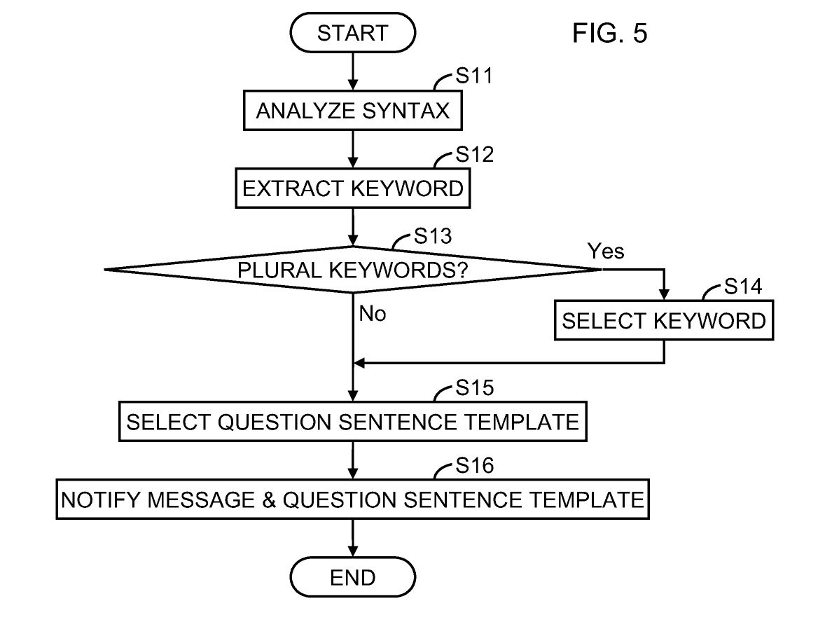

Next, operations of the text analysis server 12 will be discussed. FIG. 5 illustrates an exemplary operation flow of the text analysis server 12. The CPU 31 of the text analysis server 12 performs the operations illustrated in FIG. 5 as an example of the processor to acquire a question sentence.

In S11, the control unit 21 of the text analysis server 12 receives a message (such as an email) from the transmitting terminal among the client terminals 11-1 to 11-3. Upon receiving the message, the control unit 21 of the text analysis server 12 analyzes syntax of a text of the received message and extracts terms included in the received message.

In S12, the control unit 21 of the text analysis server 12 references the keyword DB 41 to extract a keyword that represents the content of the message. In this case, the control unit 21 of the text analysis server 12 divides the message into terms on the basis of parts of speech and extracts the terms. Then, the control unit 21 of the text analysis server 12 references the keyword DB 41 using the extracted terms as keys, and identifies a term group that includes the extracted terms. Then, the control unit 21 of the text analysis server 12 extracts the keyword corresponding to the identified term group. In this case, the control unit 21 of the text analysis server 12 may limit the extracted terms to terms of a specific part of speech and extract the limited terms. The specific part of speech may be a noun, verb or the like.

An exemplary case will be discussed below, in which the keyword DB 41 is the database illustrated in FIG. 4 and the message transmitted from the transmitting terminal includes the terms “DL”, “deadline”, “due date” and the like. In this case, the control unit 21 of the text analysis server 12 references the term data section 46 and extracts the term “TIME LIMIT” as a keyword that corresponds to the terms “DL”, “deadline”, “due date” and the like. Similarly, when the message transmitted from the transmitting terminal includes terms “essential”, “cautionary” and the like, the control unit 21 of the text analysis server 12 extracts a term “IMPORTANT” as a keyword.

In S13, the control unit 21 of the text analysis server 12 determines whether the control unit 21 of the text analysis server 12 has extracted a plurality of keywords. For example, when the control unit 21 of the text analysis server 12 has extracted a plurality of terms from the message, and the extracted terms are included in different term groups of the keyword DB 41, respectively, the control unit 21 of the text analysis server 12 may extract a plurality of keywords. When the control unit 21 of the text analysis server 12 has extracted a single keyword (“No” in S13), the control unit 21 of the text analysis server 12 advances the process to S15.

In S14, when the control unit 21 of the text analysis server 12 has extracted the plurality of keywords (“Yes” in S13), the control unit 21 of the text analysis server 12 requests the transmitter who has transmitted the message from the transmitting terminal to select a keyword having the highest priority. In this case, the control unit 21 of the text analysis server 12 may request the transmitter through a website or the like, which is provided to the transmitting terminal. The priorities may be assigned to the keywords in advance so that the control unit 21 of the text analysis server 12 may automatically select the keyword having the highest priority. In this case, he control unit 21 of the text analysis server 12 may present keywords other than the automatically selected keyword to the transmitter and prompt the user to change the keyword as appropriate.

When the control unit 21 of the text analysis server 12 has extracted the plurality of keywords and the number of the extracted keywords is equal to or smaller than a predetermined value, the test generation server 13 may generate understanding level tests (discussed later) for the respective keywords through operations discussed later without the keyword selection. When the control unit 21 of the text analysis server 12 has extracted the plurality of keywords and the number of the extracted keywords is larger than the predetermined value, the control unit 21 of the text analysis server 12 may prompt the user to select keywords from among the plurality of keywords so that the number of the selected keywords is equal to or smaller than the predetermined value.

In S15, the control unit 21 of the text analysis server 12 references the question sentence template DB 42 to select a question sentence template that corresponds to each of the selected keywords.

In S16, the control unit 21 of the text analysis server 12 notifies the test generation server 13 of the selected question sentence template and the message.

Specifically, in the aforementioned example, when the control unit 21 of the text analysis server 12 has extracted the term “TIME LIMIT” as the keyword, the control unit 21 of the text analysis server 12 may select the question sentence template “When is the time limit?”. When the control unit 21 of the text analysis server 12 has extracted the term “IMPORTANT” as the keyword, the control unit 21 of the text analysis server 12 may select a question sentence template “What is an important item?”. Then, the control unit 21 of the text analysis server 12 transmits the message and the selected question sentence template to the test generation server 13.

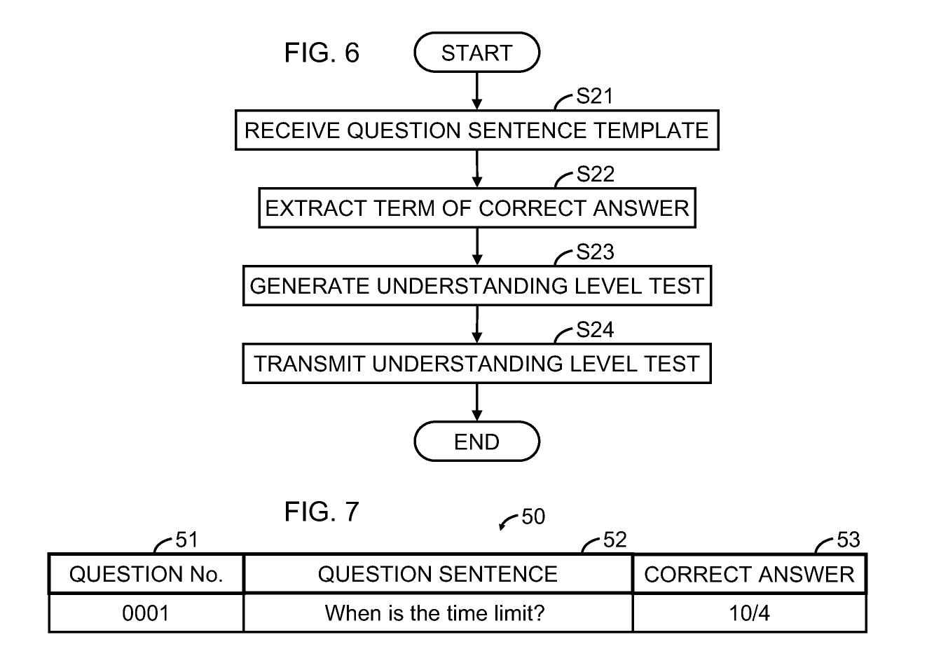

FIG. 6 illustrates an exemplary operation flow of the test generation server 13.

In S21, a control unit (hereinafter merely referred to as the test generation server 13) of the test generation server 13 receives the question sentence template.

In S22, the test generation server 13 extracts or generates, from the message, a term that is a correct answer to the content of the question of the received question sentence template. The term that is the correct answer corresponds to correct answer data discussed later. A CPU of the test generation server 13 performs the operation of S22 as an example of the processor to acquire a character string corresponding to the term.

In S23, the test generation server 13 generates an understanding level test. The content of the generated understanding level test is referred to as understanding level test data. The understanding level test data includes the correct answer data extracted in the aforementioned S22. The CPU of the test generation server 13 performs the operation of S23 as an example of the processor for generating test information.

FIG. 7 illustrates an exemplary data format of the understanding level test data. Understanding level test data 50 has question number (No.) data 51 for identifying a record of the understanding level test data 50, question sentence data 52 representing the content of the question, and correct answer data 53 representing a correct answer to the question. It may be said that the question number data 51 is data that identifies a record of the understanding level test data 50 and the question sentence data 52.

In the operation of S22, the term (word) that has been extracted by the text analysis server 12 in S11 illustrated in FIG. 5 may be used for extracting the term that is the correct answer to the content of the question of the question sentence template. For example, a number that corresponds to a time limit, an amount or a quantity, which is located before or after the extracted term (word) in the message text, may be the term that is the correct answer. The term that is the correct answer to the content of the question of the question sentence template is also referred to as correct answer data.

Specifically, the numbers correspond to parts indicated by a symbol X of “X items”, “X pieces”, “X days”, “X months”, “X years”, “X hours” and the like. For example, when the term extracted from the message is “deadline”, “time limit”, “extension”, “grace period” or the like, a term that corresponds to a date, a time period or the like may be searched from portions, in the message, located near the term extracted from the message. When the term extracted from the message is an acquired amount, a purchased amount, a used amount or the like, a term that is related to an amount may be searched from portions, in the message, located near the term extracted from the message.

The test generation server 13 may hold, in a database corresponding to the keyword DB 41 or the question sentence template DB 42 illustrated in FIG. 4, supporting terms that support the generation of the understanding level test. For example, the test generation server 13 may hold, for each of terms, for each of keywords, or for each of question sentences, a character string to be added as a unit to the term (number or the like) that is the correct answer to the question sentence. Specifically, the test generation server 13 may store terms “year”, “month”, “day”, “hour”, “minute”, “:” and the like as supporting terms corresponding to the keyword “TIME LIMIT”. The test generation server 13 may store terms “l (liter)”, “m³ (cubic meter)”, “kg”, “g”, “t” and the like that indicate amounts and correspond to a term group including the terms “acquired amount”, “purchased amount”, “used amount” and the like. The test generation server 13 may store terms “number”, “point”, “sheet”, “pair” and the like, which correspond to a term group including terms “acquired quantity”, “purchased quantity”, “used quantity” and the like.

The test generation server 13 may search for a supporting term for supporting the generation of the understanding level test from portions, in the message, located before or after the terms extracted by the text analysis server 12, to extract correct answer data.

In S24, the test generation server 13 transmits the generated understanding level test to the interested client terminal. Upon receiving the understanding level test, the client terminal adds the received understanding level test to the original message, and transmits the message as an email to the receiving terminal through the mail server 14.

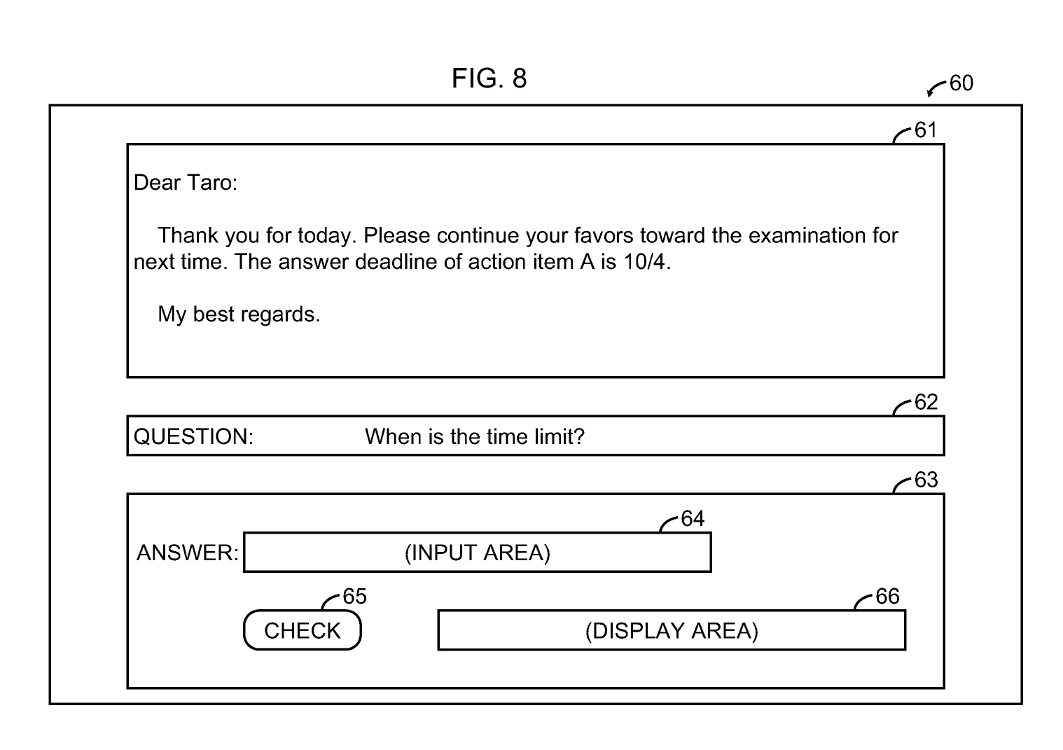

FIG. 8 illustrates an exemplary screen for displaying an email including the understanding level test. As illustrated in FIG. 8, an email screen 60 for displaying an email including an understanding level test has an email body section 61 for displaying the content of the original email, a question sentence section 62 for displaying question sentence data and an answer input section 63 in which the receiver enters an answer to the question. It may be said that the question sentence section 62 and the answer input section 63 form a user interface for conducting the understanding level test.

The answer input section 63 has an input box 64 in which the receiver enters the answer, an answer check button 65 used by the receiver to instruct to check whether the entered answer is correct or not, and a check result display box 66 for displaying the check result.

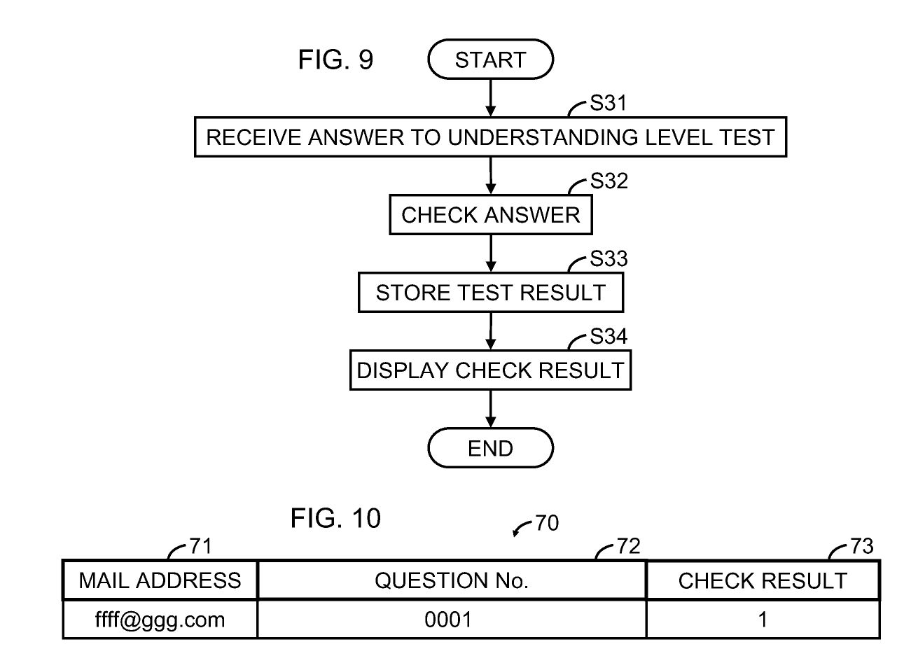

FIG. 9 illustrates an exemplary operation flow of the communication result management server 15. The operations illustrated in FIG. 9 are hereinafter referred to as an answer evaluation process.

In S31, when the receiver enters an answer to the understanding level test from the receiving terminal that has received the understanding level test, the communication result management server 15 receives the answer on a web page built on the communication result management server 15. The operation of S31 is referred to as an answer reception process. The CPU of the communication result management server 15 performs the operation of S31 as an example of a processor to acquire an answer.

In S32, the communication result management server 15 checks answer data (receiver's answer data) entered by the receiver against the correct answer data. The communication result management server 15 may display, to the receiver, a response indicating whether the answer is correct on the basis of the check result. The CPU of the communication result management server 15 performs the operation of S32 as an example of the processor to determine the level (understanding level) of understanding.

In S33, the communication result management server 15 adds, to the receiver's answer data, an evaluation data indicating a correct answer or an incorrect answer, and stores the receiver's answer data accompanied with the evaluation data in a storage device that is, for example, the RAM 33, the external storage unit 27 or the like illustrated in FIG. 3. The receiver's answer data accompanied with the evaluation data is referred to as test result data.

FIG. 10 illustrates an exemplary data format of the test result data. The test result data 70 has mail address data 71 representing an email address of the receiver (answerer) of the understanding level test, question number data 72 for identifying a record of the question data as discussed above, and check result data 73 representing the evaluation data. The mail address data 71 is an example of identification information for identifying the receiver. The check result data 73 is the evaluation data indicating whether the answer to the question identified by the question number data 72 is correct or incorrect. For example, the check result data 73 is “1” for a correct answer, “0” for an incorrect answer.

In S34, the communication result management server 15 displays, in the check result display box 66, the message that includes the check result data (evaluation data) corresponding to the answer.

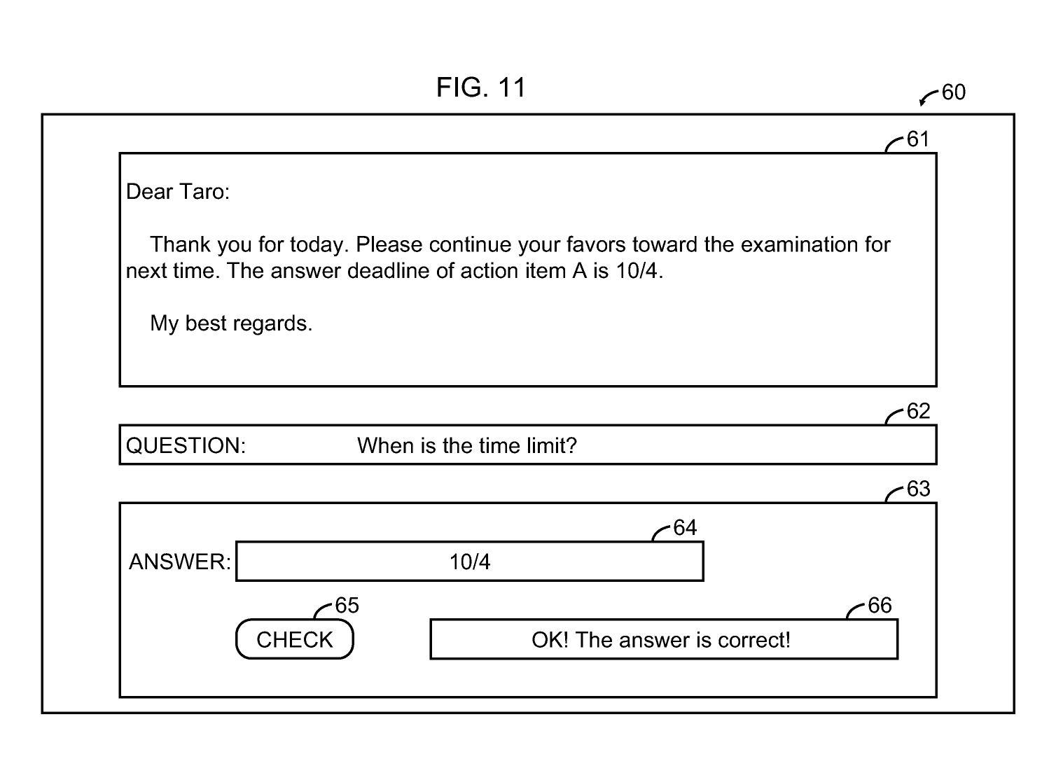

FIG. 11 illustrates an exemplary screen for displaying the check result. Specifically, when the check result data 73 indicates a correct answer, a message “OK! The answer is correct!” is displayed in the check result display box 66 as illustrated in FIG. 11. When the check result data 73 indicates an incorrect answer, a message “NG! Please enter an answer again!” is displayed, for example. These messages are examples and arbitrary messages may be used.

When the answer is incorrect, the number of incorrect answers may be counted. The message may be changed on the basis of the counted number of the incorrect answers. In addition, when the number of incorrect answers exceeds a predetermined value, an alarm email may be transmitted to a boss of the receiver by preregistering email address of the boss of the receiver.

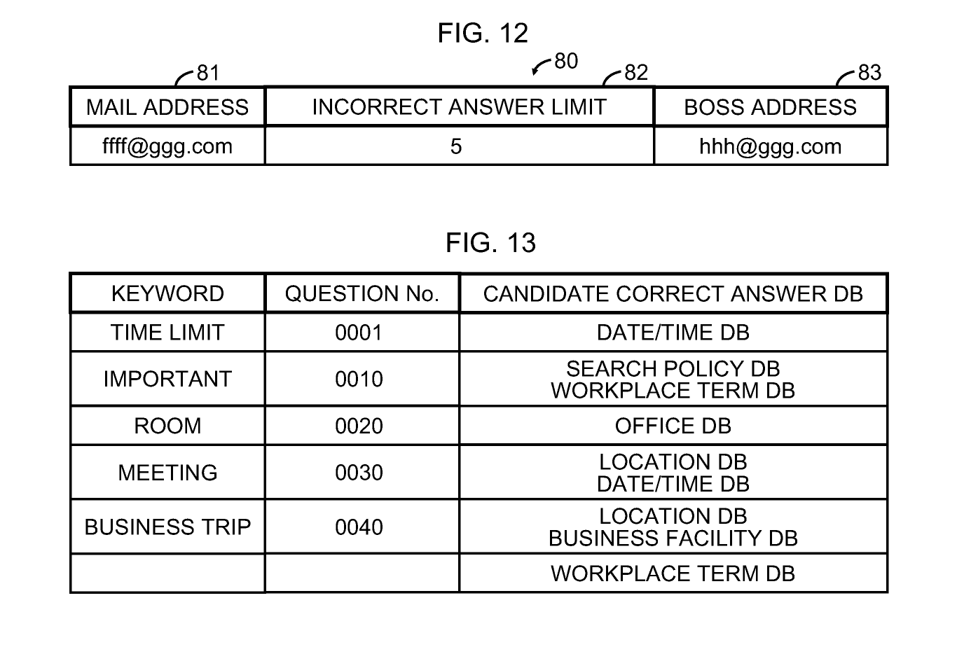

FIG. 12 illustrates an exemplary data format of basic data for transmission of the alarm email. The basic data 80 for transmission of the alarm mail has mail address data 81, incorrect answer limit data 82 and boss address data 83. The mail address data 81 represents data of an email address of the receiver of the message, that is, the answerer to the understanding level test. The incorrect answer limit data 82 represents an upper limit of the number of incorrect answers. The boss address data 83 represents data of an email address of a direct boss of the answerer to the understanding level test.

The communication result management server 15 manages the basic data for transmission of the alarm email. The communication result management server 15 monitors whether the number of incorrect answers entered by the answerer to the question sentence of the understanding level test, who corresponds to the mail address data 81, exceeds the upper limit represented by the incorrect answer limit data 82. When the number of the incorrect answers exceeds the upper limit represented by the incorrect answer limit data 82, the communication result management server 15 determines that responses of the answerer to the message are poor or that the understanding level of the answerer in regard to the messages is low. Then, the communication result management server 15 references the boss address data 83 and transmits, to the email address of the direct boss of the answerer, a report indicating that the responses of the answerer to the messages are poor or that the understanding level of the answerer in regard to the message is low.

As discussed above, the information processing system 10 according to the present embodiment may easily determine whether the receiver of the message has understood the message as intended by the transmitter of the message and manage the result of the determination. The question sentence that is used to confirm whether the receiver of the message has understood the message is generated through operations performed by the text analysis server 12 and the test generation server 13. The communication result management server 15 determines whether the answer to the question sentence of the understanding level test is correct. In this manner, the information processing system 10 may provide functions which are not provided for conventional emails, groupware, workflow management systems and the like. The information processing system 10 may achieve the function of confirming the understanding level of the receiver, the function of taking measures to make the receiver understand the message, and the function of performing the follow-up, which are very important to organizational management but not provided in conventional techniques.

In the present embodiment, since a keyword corresponding to a term group is defined in the keyword DB 41 illustrated in FIG. 4, it is easily to derive a common concept from various terms included in various messages. In the present embodiment, a question sentence template corresponding to the keyword is defined in the question sentence template DB 42 illustrated in FIG. 4. Therefore, it may be possible to increase a possibility that an appropriate question sentence is obtained for the common concept derived from the various terms included in the various messages. That is, it may be possible to increase a possibility that an appropriate question is provided to the receiver.

In the present embodiment, the test generation server 13 finds the correct answer data from the portions that are included in the message and located near the term serving as the basis of the selection of the question sentence template as illustrated in FIG. 6. Therefore, it may be possible to increase a possibility that the data of the correct answer to the question sentence is found.

### Modified Example

In the present embodiment, the test generation server 13 extracts, as the correct answer data from the message, a number corresponding to the term “time limit”, “amount”, or “quantity”, which is located, in the message, before or after the term (word) that has been extracted by the text analysis server 12. Alternatively, a common term within a workplace may be treated as a value extracted as the correct answer data. For example, when the term (word) that is extracted in S11 illustrated in FIG. 5 means a location, a term “conference room”, “reception room”, “project A”, “issue about SSS” or the like, which is common term within a workplace, a frequently used term or an abbreviated term, may be extracted. The test generation server 13 may extract, as correct answer data, a word such as a geographical name (such as “Nagoya”), “AAA factory”, or “BBB branch office”, which is related to matters such as having a visitor, a business trip and the like.

An auxiliary database that is referenced by the test generation server 13 may be prepared. For example, in the auxiliary database, supporting terms may be defined for the terms extracted from the message, for keywords corresponding to the terms and identified on the basis of the keyword DB 41, or for question sentence templates identified on the basis of the keywords. The supporting terms are terms that may be referenced by the test generation server 13 and used as references for extraction of correct answer data. For example, terms that are frequently used in a workplace in which the test generation server 13, the text analysis server 12 and the like are placed may be defined in the auxiliary database, as the supporting terms. The supporting terms may be classified and stored in a database that corresponds to keywords or question sentences.

FIG. 13 illustrates an exemplary data format of an auxiliary database according to the present embodiment. As illustrated in FIG. 13, the auxiliary database has a keyword section storing a keyword of the keyword DB 41, a question number section storing a question number for identifying a question sentence, and a candidate correct answer DB section storing information for identifying a candidate correct answer database. A table in the data format illustrated in FIG. 13 may be stored in a memory of the test generation server 13, the external storage unit, or the like. Each of the candidate correct answer databases may store data which the test generation server 13 references as reference data for identifying the keyword or the answer to the question from the message.

In FIG. 13, a date/time DB is assigned for a combination of the keyword “TIME LIMIT” and a question number “0001”, for example. In order to extract, from the message, a correct answer to the question corresponding to the question number “0001” or the keyword “TIME LIMIT”, the test generation server 13 may reference the table illustrated in FIG. 13 and identify the date/time DB. For example, the date/time DB stores terms such as “year”, “month”, “day”, “hour”, “minute”, “before noon”, “afternoon”, “morning”, “daytime”, “night”, “midnight”, and “noon” that are related to dates and times. The test generation server 13 may extract correct answer data by searching for, from the message, a term relating to dates and times, which is stored in the date/time DB. The date/time DB may store a format for dates and times in addition to the terms relating to dates and times.

In FIG. 13, a search policy DB is assigned for a combination of the keyword “IMPORTANT” and a question number “0010”, for example. The search policy DB may store a policy for searching for correct answer data from a message. An event that is critical for a workplace, a concept relating to a duty, or the like, is defined as the policy. The concept relating to the duty is, for example, a sales amount, a profit, an order receipt, a budget, a customer or the like. The test generation server 13 may estimate that a term defined in the search policy DB or an expression that includes the term, is a correct answer. A workplace term DB may be used in place of the search policy DB. The workplace term DB may store terms, which are frequently used in each of workplaces in which the text analysis servers 12, the test generation servers 13 and the like are placed. For example, the workplace term DB may store the names of customers, the names of business partners, the names of business offices with which people in the workplace frequently have contact, the names of administrative institutions, and the like.

In FIG. 13, an office DB is assigned for a keyword “ROOM”. The office DB may store the names of rooms included in the office within the workplace, or the names of management organizations. Similarly, a location DB, the date/time DB and the like are assigned for a keyword “MEETING”. The location DB may store terms that correspond to a location at which the meeting takes place, such as “conference room A”, “reception room 1”. Further, the location DB, a business facility DB and the like are assigned for a keyword “BUSINESS TRIP”. The business facility DB may store terms “office A”, “division B”, “headquarter” and the like, for example. In addition, terms that are considered to be important to each of workplaces in which the text analysis servers 12, the test generation servers 13 and the like are placed may be stored in the workplace term DB without assigning the workplace term DB for any keyword or question sentence.

Thus, the auxiliary database storing the supporting terms may provide references or supporting information when the test generation server 13 determines correct answer data included in a message. For example, when the test generation server 13 has found, in the message, a term that matches any of the supporting terms stored in the auxiliary database, the test generation server 13 may treat the found term as the correct answer data. The auxiliary database may store information regarding relationships among a term extracted from the message, a keyword identified by the extracted term on the basis of the keyword DB 41, and the correct answer data may be described in accordance with a predetermined rule. The test generation server 13 may extract the correct answer data from the message in accordance with the rule. By using the auxiliary database illustrated in FIG. 13, it may be possible to increase a possibility that the correct answer data is found.

### Second Embodiment

In the first embodiment, the information processing system 10 provides the positive effect of the understanding level test. For example, by providing the understanding level test, it may be possible to confirm whether the receiver who has received a message such as an email from the transmitter has understood the content of an instruction described in the message and has acted in accordance with the instruction.

In the second embodiment, the information processing system 10 manages whether a schedule of the receiver who has received a message has been registered in the schedule management server 16 using the groupware. For example, the receiver of the message transmits, from the receiving terminal, a registration report indicating that the schedule has been registered as a result of understanding of the message. Then, the communication result management server 15 receives the registration report. By receiving the registration report, the communication result management server 15 may confirm that the receiver of the message has understood the content of an instruction described in the message transmitted by the transmitter, and has acted in accordance with the instruction.

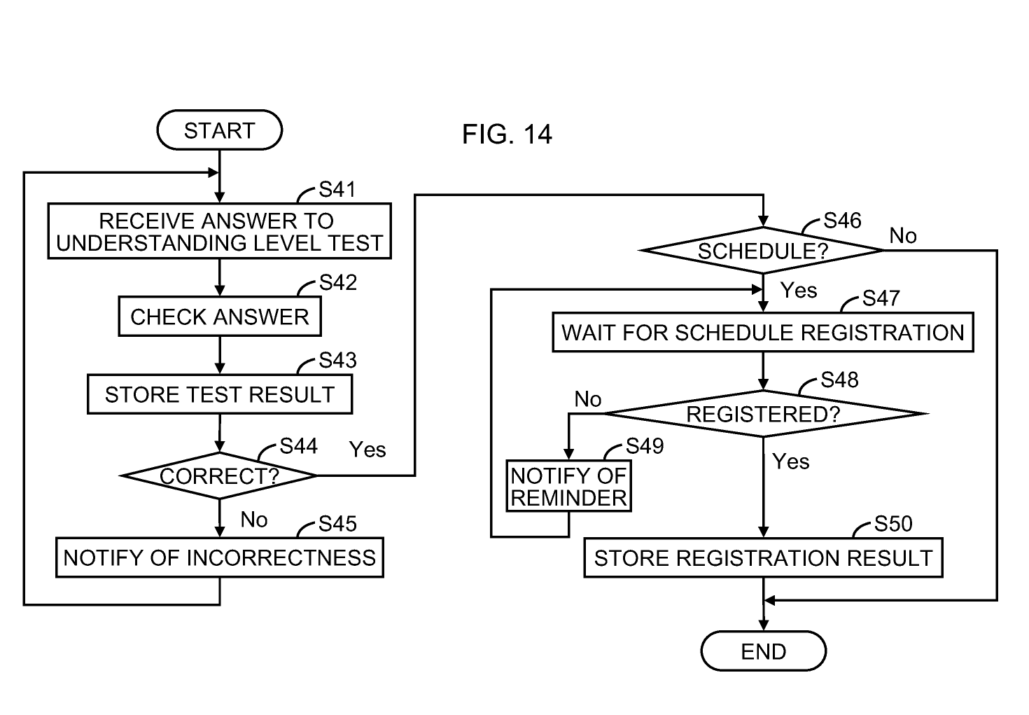

FIG. 14 illustrates an exemplary operation flow of the communication result management server 15 according to the present embodiment. The configuration of the information processing system 10 according to the present embodiment is similar to the information processing system 10 according to the first embodiment illustrated in FIG. 1. Thus, the configuration of the information processing system 10 according to the present embodiment will be discussed below with reference to FIG. 1.

In the present embodiment, in a similar manner to that in the first embodiment, the communication result management server 15 receives the result of an answer to the question sentence of the understanding level test and determines whether the answer is correct. Then, the communication result management server 15 waits for receiving from the receiving terminal (or the schedule management server 16) a report indicating that the schedule corresponding to the message has been registered. Upon receiving the report, the communication result management server 15 determines that the receiver of the email has surely understood the message and has taken an appropriate response to the message.

The operation flow illustrated in FIG. 14 is achieved by adding operations of confirming whether a schedule has been registered to the operation flow illustrated in FIG. 9. The operation flow of the communication result management server 15 will be discussed with reference to FIG. 14. Operations of S41 to S43 included in the operation flow illustrated in FIG. 14 are similar to the operations of S31 to S33 illustrated in FIG. 9, and a discussion thereof will be omitted.

In S44, upon storing the test result, the communication result management server 15 determines whether the answer entered by the receiver matches the correct answer data.

In S45, when the answer is incorrect (“No” in S44), the communication result management server 15 notifies the receiving terminal of the fact that the answer is incorrect. The receiving terminal displays the notification indicating that the answer is incorrect on a screen to make the receiver recognize that the answer to the question sentence of the understanding level test is incorrect. After that, the communication result management server 15 returns the process to S41 and receives an answer entered by the receiver again. When the number of incorrect answers that are consecutively entered by the receiver is equal to or larger than a predetermined value, the communication result management server 15 terminates the operation of S44 and advances the process to S46. Alternatively, after the communication result management server 15 notifies the receiving terminal of the fact that the answer is incorrect in S45, the communication result management server 15 may advances the process to S46 without receiving an answer entered by the receiver again. Advancing the process to S46 without receiving an answer entered by the receiver again is an example of an operation flow that is suitable for an organization in which a trusting relationship is maintained so that once the communication result management server 15 notifies the receiving terminal of the fact that the answer is incorrect, the receiver immediately confirms and understands the message.

In S46, when the result of the determination indicates that the answer is correct (“Yes” in S44), the communication result management server 15 determines whether the operation of confirming whether a schedule has been registered by the receiver needs to be performed. The operation of confirming whether a schedule has been registered needs to be performed when the message transmitted by the transmitter includes an instruction relating to the registration of the schedule, a request relating to the registration of the schedule, or the like. For example, the operation of confirming whether a schedule has been registered is performed when the message includes a time limit for a specific action, a plan for the specific action, or the like. The CPU of the communication result management server 15 performs the operation of S46 as an example of the processor to determine whether the message includes a term relating to schedule registration.

When the message transmitted by the transmitter includes an instruction relating to the registration of the schedule, a request relating to the registration of the schedule, or the like, the text analysis server 12 may extract, from the message, the instruction relating to the registration of the schedule, the request relating to the registration of the schedule or the like, for example. Upon extracting, from the message, the instruction relating to the registration of the schedule, the request relating to the registration of the schedule or the like, the text analysis server 12 may add, to the question sentence template, an instruction (schedule registration confirmation instruction) to confirm whether the schedule has been registered. Thus, the text analysis server 12 may cause the schedule registration confirmation instruction to be included in the data of the understanding level test generated by the test generation server 13.

In addition, for example, when the test generation server 13 has extracted a term “date”, “date and time” or the like as correct answer data for a term “time limit”, “plan” or the like, the test generation server 13 may cause the schedule registration confirmation instruction to be included in the data of the understanding level test.

When the data of the understanding level test includes the schedule registration confirmation instruction (“Yes” in S46), the communication result management server 15 advances the process to S47.

In S47, the communication result management server 15 waits for receiving from the receiving terminal a registration report indicating that the schedule has been registered.

In S48, the communication result management server 15 determines whether the communication result management server 15 has received from the receiving terminal the registration report for a predetermined time period. The predetermined time period is, for example, a time period from the start of the operation of waiting for the registration report in S47 to a time specified in a setting parameter of a system of the communication result management server 15. The CPU of the communication result management server 15 performs the operations of S47 and S48 as an example of the processor to determine whether the receiving terminal has reported the schedule registration.

In S49, when the communication result management server 15 has not received for the predetermined time period the registration report (“No” in S48), the communication result management server 15 transmits a reminder notification to the receiving terminal. The reminder notification may be a notification to display an instruction to register the schedule corresponding to the interested message, for example. The communication result management server 15 transmits the reminder notification so as to prompt the receiver to register the schedule corresponding to the interested message. Thereafter, the communication result management server 15 returns the process to S47 and waits again for the registration report.

Alternatively, after the communication result management server 15 transmits the reminder notification in S49, the communication result management server 15 may advances the process to S50 without waiting again for the registration report from the receiver. Advancing the process to S50 without waiting again for the report from the receiver is an example of an operation flow that is suitable for an organization in which a trusting relationship is maintained so that once the communication result management server 15 transmits the reminder notification to the receiver, the receiver immediately registers the schedule.

In S50, when the communication result management server 15 has received the registration report (“Yes” in S48), the communication result management server 15 stores the registration result indicating that the schedule has been registered, in a storage device such as the RAM 33 or the external storage unit illustrated in FIG. 3. Thereafter, the communication result management server 15 terminates the process. On the other hand, when the data of the understanding level test does not include the schedule registration confirmation instruction (“No” in S46), the communication result management server 15 terminates the process after the determination of S46.

In the operation flow illustrated in FIG. 14, when the communication result management server 15 has received from the receiver of the message the registration report, the communication result management server 15 determines that the schedule has been registered, and the communication result management server 15 stores in the storage device the registration result. Alternatively, the communication result management server 15 may receive the registration result from the schedule management server 16. For example, when the receiver has registered a plan of the receiver in the schedule, the schedule management server 16 may transmit, to the communication result management server 15, identification information for identifying the receiver, a date and time when the schedule has been registered, and the like. Specifically, the communication result management server 15 may wait for receiving the report from the schedule management server 16 in S47 illustrated in FIG. 14.

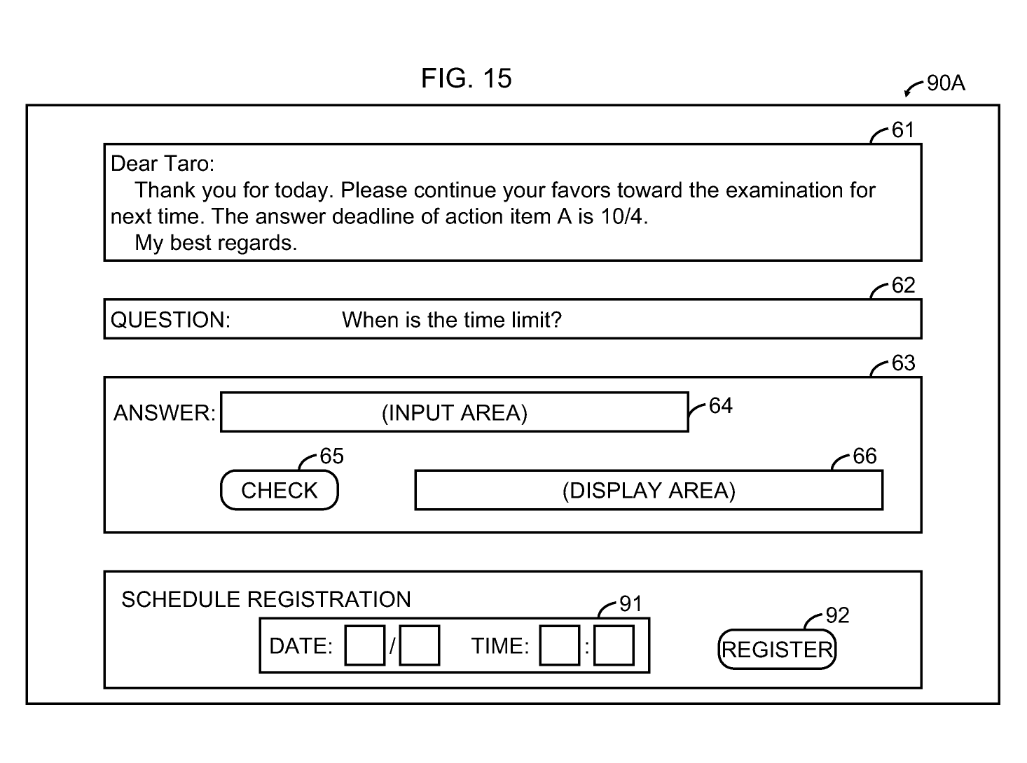

The information processing system 10 may use, so as to manage whether the schedule has been registered, a user interface for displaying an email or a message in a workflow or the like, entering an answer to a question sentence of an understanding level test, and registering a schedule in the schedule management server 16. FIG. 15 illustrates an exemplary screen for displaying the message, entering an answer to the question sentence of the understanding level test, and registering the schedule in the schedule management server 16. In FIG. 15, parts that are similar to the parts illustrated in FIG. 8 are indicated by similar reference numerals.

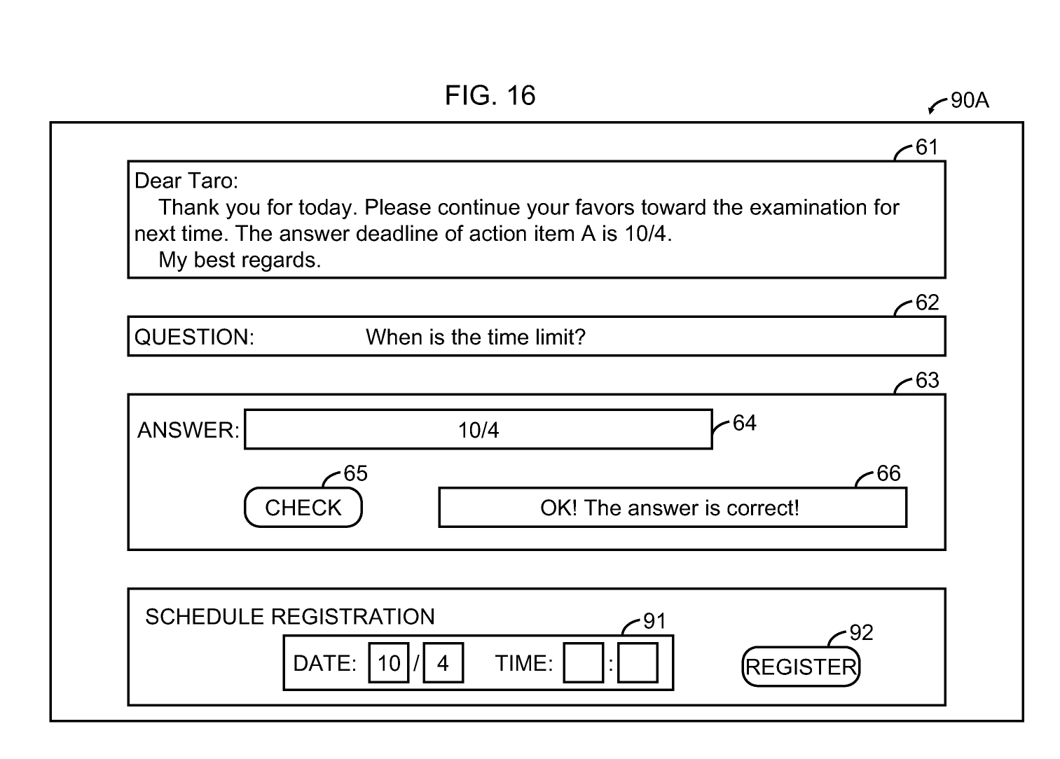

As illustrated in FIG. 15, an email screen 90A includes an email body section 61 for displaying the content of the original email, a question sentence section 62 for displaying question sentence data, an answer input section 63 in which the receiver enters an answer to the question, a date input section 91 in which the receiver enters a scheduled date corresponding to the message of the original email, and a schedule registration button 92 used by the receiver to register the schedule in the schedule management server 16. The answer input section 63 has an input box 64 in which the receiver enters the answer, an answer check button 65 used by the receiver to instruct to check whether the entered answer is correct or not, and a check result display box 66 for displaying the check result. FIG. 16 illustrates an exemplary screen for displaying the check result. Specifically, when the check result data 73 indicates a correct answer, a message “OK! The answer is correct!” is displayed in the check result display box 66 as illustrated in FIG. 16.

In parallel with this, when an answer that is entered by the receiver who has received the understanding level test is correct, and the receiver has clicked on the schedule registration button 92, the schedule may be registered in the schedule management server 16. Specifically, the schedule that corresponds to the content of the message of the original email may be registered in the schedule management server 16 on the scheduled date displayed in the date input section 91. When the schedule has been registered, the schedule management server 16 transmits, to the communication result management server 15, a registration report indicating that the registration of the schedule has been completed. Alternatively, when the schedule registration button 92 is clicked, the receiving terminal on which the email screen 90A is displayed may transmit, to the communication result management server 15, the registration report. Since the receiving terminal transmits, to the communication result management server 15, the registration report, it may be possible to suppress the need to add a new constituent part to the schedule management server 16.

As discussed above, according to the present embodiment, an action of the receiver of the message may be confirmed, for example, registration of the schedule in the schedule management server 16 by the receiver in accordance with the content of the message may be confirmed. Specifically, according to the present embodiment, it may be determined that information has been correctly communicated through the message when the communication result management server 15 confirms that the receiver of the message has understood the content of the message and has taken an appropriate response to the message. Thus, the convenience may be improved for confirming that information has been correctly communicated to the receiver of the message.

The present embodiment discusses, as an example, the operation of registering a schedule in the schedule management server 16. However, the information processing system 10 according to the present embodiment may be applied to another operation. Specifically, the operations similar to that of the present embodiment may be performed in order to perform follow-up to confirm whether a routine business document to be created in response to routine business other than a registration of a schedule has been created. The routine business document is, for example, a document such as a daily report, a weekly report, a monthly report, or a settlement note that is periodically created, or a document such as a business trip report that is created in response to an occurrence of an event. When the message includes an instruction to create the aforementioned routine business document, the communication result management server 15 may determine whether a report, which indicates that the routine business document has been created, has been received for a predetermined time period from the time when the instruction to create the document is provided.

Specifically, the text analysis server 12 may store, in its own database, a database storing a document name to be managed. When the text analysis server 12 finds the document name in the message, the text analysis server 12 may instruct the communication result management server 15 to manage whether a report has been received, which indicates that a document corresponding to the found document name has been created. The communication result management server 15 may manage, in accordance with the instruction provided by the text analysis server 12, whether the report provided from the receiver has been received for the predetermined time period.

Alternatively, the text analysis server 12 may store, in its own database, a database storing a business task (for example, a business trip) and a document name (for example, a business trip report) to be managed, for example. Upon finding a term indicating the business task from the message, the text analysis server 12 may instruct the communication result management server 15 to manage whether a report has been received, which indicates that a document having the document name corresponding to the found business task has been created. The communication result management server 15 may manage, in accordance with the instruction provided by the text analysis server 12, whether the report provided from the receiver has been received for a predetermined time period, and perform follow-up (operation of taking measures against a delay of the report).

### Third Embodiment

In the second embodiment, for example, the communication result management server 15 confirms, on the basis of the answer of the receiver to the question sentence of the understanding level test regarding the message, whether the receiver has understood the message and has acted on the basis of the understanding, in a similar manner to that in the first embodiment. The communication result management server 15 receives the understanding level test and the registration report indicating that the schedule has been registered. On the basis of the registration report, the communication result management server 15 confirms that the receiver of the email has understood the content of the instruction described in the message of the email and has acted in accordance with the instruction.

The third embodiment discusses an example of an operation of confirming the understanding level of the receiver by receiving a registration report indicating that a schedule has been registered, instead of the understanding level test discussed in the first embodiment. In the present embodiment, the understanding level test discussed in the first embodiment will be omitted. A configuration and effect of the third embodiment are the similar to that of the first embodiment or the second embodiment, except that a registration report indicating that a schedule has been registered is received instead of the understanding level test. The configuration discussed in the first embodiment is applied to the present embodiment unless otherwise stated. In the present embodiment, parts that are similar to the parts discussed in the first and second embodiments are indicated by similar reference numerals, and a discussion thereof will be omitted.

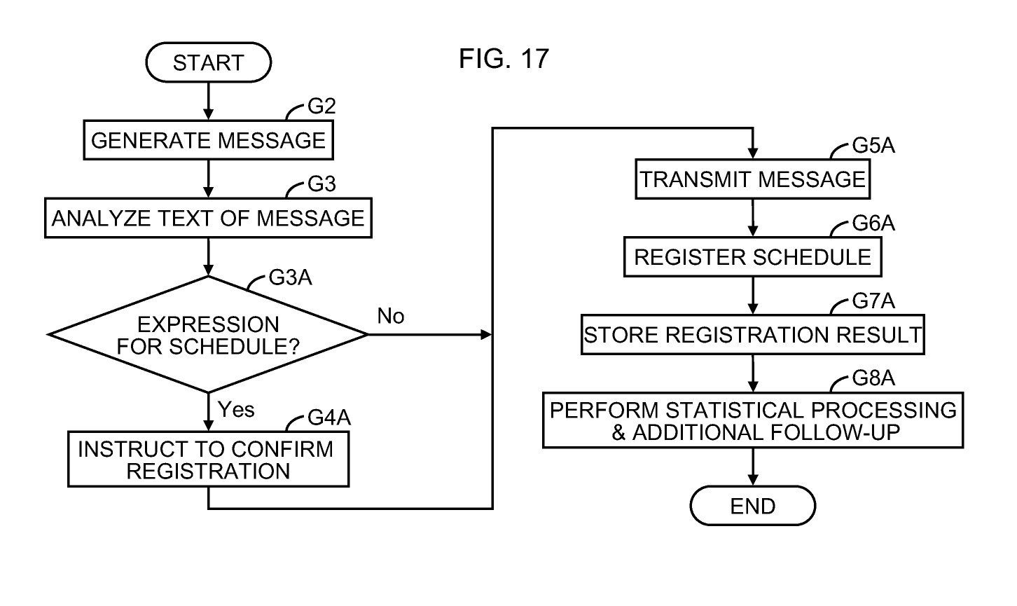

FIG. 17 illustrates an exemplary operation flow of the client terminals 11-1 to 11-3, the text analysis server 12, the mail server 14, the communication result management server 15 and the like in the information processing system 10 according to the present embodiment. The information processing system 10 according to the present embodiment may not include the test generation server 13.

Compared with the operation flow illustrated in FIG. 2, the information processing system 10 according to the present embodiment does not perform the operation of registering a keyword and a question sentence template in preparation for the analysis of the message text, the generation of the understanding level test, and the like.

In G2, a transmitting terminal among the client terminals 11-1 to 11-3 and the like generates a message such as an email in accordance with a user operation. The operation of G2 is performed in a similar manner to that of the first embodiment.

In G3A, the transmitting terminal transmits the generated message to the text analysis server 12. Then, the text analysis server 12 analyzes a message text. In the analysis of the message text in the third embodiment, the text analysis server 12 extracts a term from the message. Then, the text analysis server 12 determines whether an expression relating to a registration of a schedule is included in the message.

The expression that is related to the registration of the schedule is an expression regarding a time limit, a plan or the like. The text analysis server 12 may have a format corresponding to a time limit, a plan or the like stored in the database. Examples of the formats corresponding to the terms “time limit”, “plan” and the like are “<month> <num_d>, <num_y>”, “<num_M>/<num_d>”, “<num_h> <am_pm>”, “<num_h>:<num_m>”, and “<day_w>”. The variable <month> matches a name of month such as “January”, “Jan”, or the like. The variable <num_d> matches an integer from “1” to “31”. The variable <num_y> matches a four-digit integer or two-digit integer. The variable <num_h> matches an integer from “0” to “11”. The variable <num_M> matches an integer from “1” to “12”. The variable <am_pm> matches “AM” or “PM”. The variable <num_m> matches an integer from “0” to “59”. The variable <day_w> matches a name of a day of the week such as “Sunday”, “Sun”, or the like. When an expression of the format “<month> <num_d>, <num_y>” or “<num_M>/<num_d>” is included in the message, for example, the text analysis server 12 may determine that a date is described in the message.

When an expression of the format “<num_h> <am_pm>” or“<num_h>:<num_m>” is included in the message, for example, the text analysis server 12 may determine that a time is described in the message. When an expression of the format “<day_w>” is included in the message, for example, the text analysis server 12 may determine that a day of the week is described in the message.

In G4A, when the expression relating to the registration of the schedule is included in the message, the text analysis server 12 instructs the communication result management server 15 to confirm whether the schedule has been registered. In order to instruct to confirm whether the schedule has been registered, the text analysis server 12 may transmit, to the communication result management server 15, information regarding the transmitter of the message, information regarding the receiver of the message, the expression relating to the registration of the schedule, which has been extracted by analyzing the message text in G3. The information transmitted to the communication result management server 15 may be, for example, information for identifying the transmitter, information for identifying the receiver, and the date or the time of the schedule to be registered.

In G5A, the transmitting terminal transmits the message in accordance with an operation of the transmitter. The transmission of the message is performed in a similar manner to that of G5 in the first embodiment illustrated in FIG. 2.

In G6A, upon receiving the message, the receiving terminal displays the received message on the screen for the receiver. When the message includes an expression relating to a schedule, the receiver operates a schedule management tool of the receiver so as to register the schedule. Then, the receiver inputs to the communication result management server 15 a registration result indicating that the schedule has been registered. For example, the receiving terminal transmits, to the communication result management server 15 in accordance with an operation of the receiver, a report that includes the registration result. The report includes the expression relating to the schedule and information regarding the receiver of the message relating to the schedule. The report may include information regarding the transmitter of the message.

In G7A, the communication result management server 15 receives the report that includes the registration result, and stores the received report including the registration result. In this case, the communication result management server 15 holds an expression relating to the schedule of the receiver and information for identifying the receiver from which the communication result management server 15 waits for the report. In addition, the communication result management server 15 may store information regarding the transmitter of the message. Upon receiving, from the receiving terminal, a report that matches the expression relating to the schedule of the receiver and the information for identifying the receiver from which the communication result management server 15 waits for the report, the communication result management server 15 may determine that the communication result management server 15 has received the report from the receiver from which the communication result management server 15 waits for the report. Then, the communication result management server 15 may store and hold, for each of the identifier of receivers, information regarding a fact that the report has been received from the receiver.

In G8A, the communication result management server 15 performs a statistical processing or additional follow-up for the received reports for each of the identifiers of the receivers. The statistical processing means to calculate the ratio of the number of reports received by the communication result management server 15 to the number of reports for which the communication result management server 15 waits, to store data of a temporal transition of the calculated result, and the like. The additional follow-up means to transmit a reminder to a receiver who has not transmitted a report after a predetermined time elapses, to transmit a cautionary message to a receiver whose ratio of the number of reports transmitted to the communication result management server 15 to the number of reports for which the communication result management server 15 waits from the receiver is lower than a reference value, to transmit a notification to a boss of the receiver whose ratio of the number of the reports transmitted to the communication result management server 15 to the number of the reports for which the communication result management server 15 waits from the receiver is lower than the reference value, and the like.

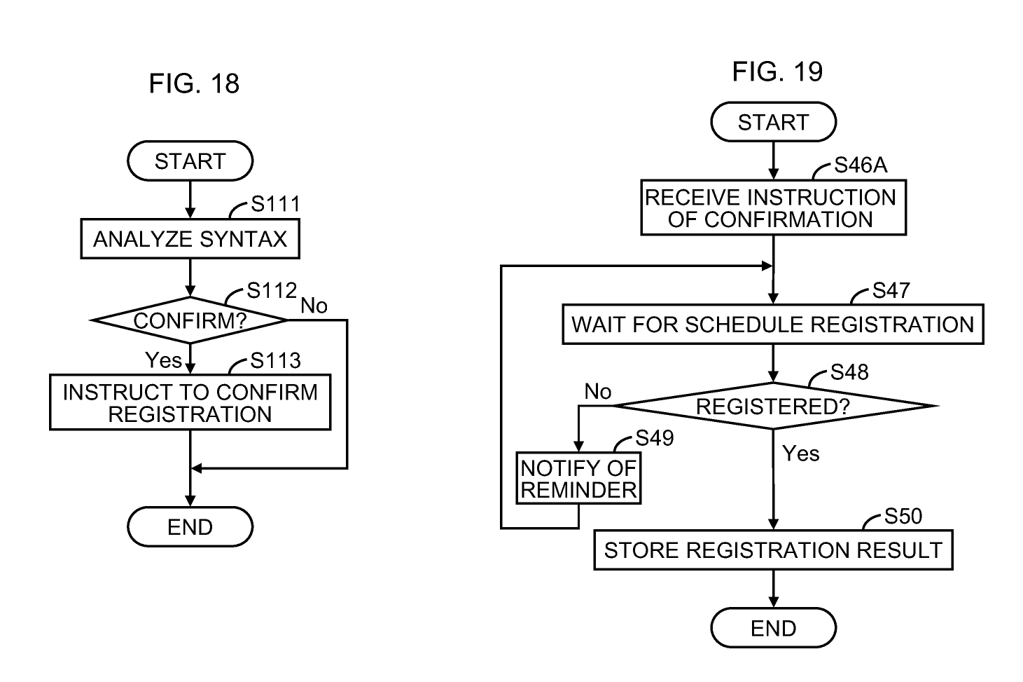

FIG. 18 illustrates an exemplary operation flow of the text analysis server 12 according to the present embodiment.

In S111, upon receiving a message, the text analysis server 12 analyzes syntax of a text of the received message and extracts terms included in the received message.

In S112, the text analysis server 12 checks the extracted term against formats corresponding to terms “time limit”, “plan” and the like, that are stored in the database of the text analysis server 12. Then, the text analysis server 12 determines whether to instruct the communication result management server 15 to confirm the registration of the schedule on the basis of whether the message includes an expression relating to a registration of a schedule. The text analysis server 12 performs the operations of S111 and S112 as an example of the processor to determine whether the message includes a term relating to schedule registration.

In S113, when the message includes an expression relating to a registration of a schedule, the text analysis server 12 instructs the communication result management server 15 to confirm whether the schedule has been registered.

FIG. 19 illustrates an exemplary operation flow of the communication result management server 15 according to the present embodiment.

In S46A, the communication result management server 15 receives, from the text analysis server 12, the instruction to confirm whether the schedule has been registered.

Then, the communication result management server 15 performs operations of S47 to S50. The operations of S47 to S50 are similar to the operations of S47 to S50 illustrated in FIG. 14, and a discussion thereof will be omitted.

As discussed above, the information processing system 10 according to the present embodiment confirms whether the schedule has been registered. In the present embodiment, the information processing system 10 may confirm whether the receiver has understood the message and acted in accordance with the message by confirming the registration of schedule instead of conducting the understanding level test. Since the information processing system 10 according to the present embodiment does not need to conduct the understanding level test, the possibility that a load of the receiver may be reduced is high, compared with the first embodiment.

In the present embodiment, the receiver notifies, from the receiving terminal, the communication result management server 15 of the registration result indicating that the schedule has been registered. Instead of this configuration, the schedule management tool in which the schedule is registered may notify the communication result management server 15 of the registration result. Alternatively, a system that provides a function such as the groupware may notify the communication result management server 15 of the registration result.

In this case, the load of the receiver may be further reduced. When the receiver registers the schedule in the schedule management tool, the schedule management server 16 may transmit, to the communication result management server 15, a registration report indicating that the registration of the schedule has been completed. The content of the registration report is similar to that of the second and third embodiments. Alternatively, for example, when the schedule registration button 92 illustrated in FIGS. 15 and 16 is clicked, the receiving terminal on which the email screen 90A is displayed may transmit, to the communication result management server 15, the registration report.

The communication result management server 15 may be configured so that the communication result management server 15 is allowed to read a database which stores data of the schedule managed by the schedule management tool in which the schedule is registered or the system that provides the function such as the groupware. The communication result management server 15 may read the data of the schedule from the database to confirm whether the schedule has been registered without waiting for the registration report as illustrated in FIG. 19. In this case, the schedule management tool or the system that provides the function such as the groupware does not need to be modified. Instead of modifying the groupware or the like, a function of accessing the data of the schedule may be added to the communication result management server 15. The communication result management server 15 may check the data of the schedule of the receiver at predetermined time intervals to confirm whether the receiver has understood the message and acted in accordance with the message, for example.

Computer-Readable Medium

A program that enables a computer, a machine (other than the computer) and a device (other than the computer) (which are collectively hereinafter referred to as a computer or the like) to achieve at least one of the aforementioned functions may be stored in a computer-readable medium. The computer or the like may read the program from the medium and execute the program so as to provide the at least one of the functions.

The computer-readable medium is a medium that accumulates information such as data and programs on the basis of an electrical, magnetic, optical, mechanical or chemical effect, and from which the computer or the like is able to read the information. Examples of the computer-readable medium detachable from the computer or the like is a flexible disk, a magneto-optical disc, a CD-ROM, a CD-R/W, a DVD, a Blu-ray disc, a digital audio tape (DAT), an 8 mm tape, a memory card such as a flash memory or the like. Examples of the computer-readable medium fixed to the computer or the like is a hard disk, an ROM or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been discussed in detail, it should be understood that the various changes, substitutions, and alterations could be made hereto without departing from the spirit and scope of the invention.

What is claimed is:

1. An information processing apparatus comprising:
a processor to
acquire a question sentence corresponding to a term included in a message transmitted to a receiving terminal used by a receiver,
acquire from the message a character string corresponding to the term, and
generate test information including the question sentence and the character string as a correct answer to the question sentence.

2. The information processing apparatus according to claim 1, further comprising:
a first storage unit for storing a term group and a keyword in association with each other, the term group including a plurality of terms; and
a second storage unit for storing a keyword and a question sentence in association with each other,
wherein
the processor
acquires, from the first storage unit, a keyword associated with a term group including the term included in the message, and
acquires, from the second storage unit, a question sentence associated with the acquired keyword as the question sentence corresponding to the term included in the message.

3. The information processing apparatus according to claim 1, wherein the processor
acquires an answer to the question sentence from the receiving terminal, and
determines an understanding level of the receiver in regard to the message on the basis of the acquired answer and the character string.

4. The information processing apparatus according to claim 1, wherein the processor
determines whether the message includes a term relating to schedule registration, and
determines whether the receiving terminal has reported schedule registration within a predetermined time period when it has been determined that the message includes the term relating to schedule registration.

5. An information processing method executed by an information processing apparatus, the information processing method comprising:
acquiring a question sentence corresponding to a term included in a message transmitted to a receiving terminal used by a receiver;
acquiring from the message a character string corresponding to the term; and
generating, by the information processing apparatus, test information including the question sentence and the character string as a correct answer to the question sentence.

6. The information processing method according to claim 5, wherein
the information processing apparatus
acquires, from a first storage unit, a keyword associated with a term group including the term included in the message, and
acquires, from a second storage unit, a question sentence associated with the acquired keyword as the question sentence corresponding to the term included in the message,
wherein
the first storage unit stores, in association with each other, a keyword and a term group including a plurality of terms, and
the second storage unit stores a keyword and a question sentence in association with each other.

7. The information processing method according to claim 5, wherein
the information processing apparatus
acquires an answer to the question sentence from the receiving terminal, and
determines an understanding level of the receiver in regard to the message on the basis of the acquired answer and the character string.

8. The information processing method according to claim 5, wherein
the information processing apparatus
determines whether the message includes a term relating to schedule registration, and
determines whether the receiving terminal has reported schedule registration within a predetermined time period when it has been determined that the message includes the term relating to schedule registration.

9. A computer-readable, non-transitory medium storing a program that causes a computer to execute an information processing method comprising:
acquiring a question sentence corresponding to a term included in a message transmitted to a receiving terminal used by a receiver;
acquiring from the message a character string corresponding to the term; and
generating test information including the question sentence and the character string as a correct answer to the question sentence.

10. The computer-readable, non-transitory medium according to claim 9, wherein
the computer
acquires, from a first storage unit, a keyword associated with a term group including the term included in the message, and
acquires, from a second storage unit, a question sentence associated with the acquired keyword as the question sentence corresponding to the term included in the message,
wherein
the first storage unit stores, in association with each other, a keyword and a term group including a plurality of terms, and
the second storage unit stores a keyword and a question sentence in association with each other.

11. The computer-readable, non-transitory medium according to claim 9, wherein
the computer
acquires an answer to the question sentence from the receiving terminal, and
determines an understanding level of the receiver in regard to the message on the basis of the acquired answer and the character string.

12. The computer-readable, non-transitory medium according to claim 9, wherein
the computer
determines whether the message includes a term relating to schedule registration, and
determines whether the receiving terminal has reported schedule registration within a predetermined time period when it has been determined that the message includes the term relating to schedule registration.
